(19) United States
(12) Patent Application Publication
(10) Pub. No.: US 2003/0227994 A1
(43) Pub. Date: Dec. 11, 2003

(54) Nuclear plant

(76) Inventors: Franco Curtolo, Stellenbosch (ZA); Mark Andrew Davies, Centurion (ZA); Holger Gerhard Clemens Finken, Pretoria (ZA)

Correspondence Address: CARTER WHITE, HOWREY SIMON ARNOLD AND WHITE LLP, 750 BERING DRIVE, HOUSTON, TX, 77057, US

(21) Appl. No.: 10/311,963

(22) PCT Filed: Jun. 27, 2001
(86) PCT No.: PCT/IB01/01149

(30) Foreign Application Priority Data
Jun. 29, 2000 (ZA) 2000/3277
Sep. 8, 2000 (ZA) 2000/4761

(51) Int. Cl. G21C 19/28; G21C 15/00

(52) U.S. Cl. 376/381

(57) ABSTRACT

The invention relates to a nuclear plant (8) having a reactor (10) containing a core comprising a plurality of moderator elements in a central region and a plurality of spherical fuel elements located in an annular region around the central region. The plant (8) further includes a fuel and moderator handling system (40) for circulating fuel and moderator elements around the plant (8). It further relates to a method of loading the core with moderator and fuel elements.

THIS INVENTION relates to a nuclear plant and to a method of operation of a nuclear plant. It also relates to a method of loading a core of a nuclear reactor.

In a nuclear reactor of the high temperature gas cooled type, a fuel comprising a plurality of spherical fuel elements is used. The fuel elements or spheres may comprise spheres of a fissionable material in a ceramic matrix, or encapsulated in a ceramic material. The reactor may be helium cooled. The fuel elements are known as pebbles and a reactor of this type is generally known as a pebble bed reactor (PBR). In a PBR it is known to operate a multi-pass fuelling scheme in which fuel spheres are passed through a core of the reactor more than once in order to optimise burn-up of fuel. In comparison with other fuelling schemes, a multi-pass fuelling scheme is believed to provide for a more uniform distribution of burn-up within the core and thereby flattens the axial neutron flux profile and maximises thermal power output of the reactor core. In this specification, a reactor as described above will be referred to interchangeably as a pebble bed reactor (PBR) or a nuclear reactor of the pebble bed type.

According to one aspect of the invention there is provided a nuclear plant which includes a nuclear reactor of the pebble bed type, the reactor including a reactor core having

a plurality of spherical moderator elements located in a central region of the core at least part of the central region being generally cylindrical; and

a plurality of spherical fuel elements located in an annular region surrounding the central region.

The nuclear reactor core may include a plurality of spherical absorber elements.

In a preferred embodiment of the invention, the moderator elements are graphite spheres.

According to another aspect of the invention there is provided a nuclear plant which includes a nuclear reactor which includes

a core containing means having at least one outlet through which moderator elements and fuel elements can be discharged from the core;

at least one first inlet, the or each first inlet being configured to permit moderator elements to be loaded into a first region of the core via the or each first inlet;

at least one second inlet, the or each second inlet being configured to permit fuel elements to be loaded into a second region of the core via the or each second inlet; and

a handling system intermediate the or each outlet and the or each first and second inlet for cycling the moderator elements and the fuel elements through their respective regions of the core at a predetermined rate.

The nuclear reactor may be a pebble bed reactor, the core containing means may be a core barrel, and the first region may be a central region with the second region being an annular region surrounding the first region.

The core barrel may be generally cylindrical in shape, an operatively lower end portion of the barrel tapering inwardly to provide a funnel-shaped operatively lower end, a single outlet being defined at the operatively lower end of the barrel, a single first inlet being located at an operatively upper end of the barrel, proximate the central region of the core and a plurality of second inlets being located in an angularly spaced relation about a longitudinal axis of the barrel proximate the annular region of the core and symmetrically spaced with respect to the annular region.

The handling system may define a flow path intermediate the outlet and each of the inlets. The flow path may include a conduit arrangement including conduit lines. Motive force for the moderator and fuel elements about the handling system may be provided, at least partly, by a gas under pressure, the moderator and fuel elements being entrained, in use, in a gas flow stream flowing through the flow path. Motive force for the moderator and fuel elements may also be provided, at least in part, by gravitational force.

In a preferred embodiment of the invention, the flow path of the handling system is in fluid communication with the reactor core and the gas flow stream is provided by means of reactor coolant gas. The reactor coolant gas in at least a portion of the flow stream may be at a similar pressure to the coolant gas of a reactor pressure vessel within which the core is contained.

The handling system may have a fuel element flow path and a moderator element flow path, the handling system further including a first sort means for separating moderator elements from fuel elements in the flow path and for entraining moderator elements in a gas flow stream of the moderator element flow path and fuel elements in a gas flow stream of the fuel element flow path.

The first sort means may include a first sensor means operatively coupled to a first diverter valve. The first sensor means may be a radiation sensor and be operable to detect and measure nuclear radiation emitted by moderator elements and fuel elements in the flow stream and to generate a signal containing data representative of the radiation detected and measured, the first diverter valve being operable to divert the flow stream into a first flow path, being the moderator element flow path, a second flow path, being the fuel element flow path, and a third flow path, being a discharge flow path for discharging burnt up or damaged fuel elements.

The moderator element flow path may include a second sort means. The second sort means may include a second sensor means operatively coupled to a second diverter valve assembly, the second sensor means being a radiation sensor which is operable to detect and measure nuclear radiation emitted by moderator elements and fuel elements in the flow stream of the moderator flow path and to generate a signal containing data representative of the radiation detected and measured, the second diverter valve assembly being selectively operable to divert moderator elements into a moderator inlet line for re-loading into the reactor core and, on detection of a fuel element in the moderator element flow path, to divert such a fuel element back into the annular region of the reactor core.

The moderator element flow path may further include a buffer storage means for storing elements in the moderator element flow path to provide a time delay to assist in separating misdirected fuel elements from moderator elements in the moderator element flow path.

The handling system may include a storage system. The storage system may include a new fuel storage system for storing new fuel elements and for feeding new fuel elements at predetermined intervals into the reactor core via the second inlets, a moderator element storage system for storing graphite moderator elements, the moderator element storage system including a moderator element storage tank having an inlet and an outlet, the inlet being operatively coupled to the second diverter valve assembly of the moderator element flow path and the outlet being coupled to the same second diverter valve assembly of the moderator element flow path. Thus, by operation of the second diverter valve assembly, graphite spheres discharged from the reactor core may be diverted to the moderator element or graphite sphere storage tank for storing, rather than being recycled back into the reactor core, thereby enabling the complete discharge of graphite spheres from the reactor core for core maintenance purposes. As required, the reactor core may be re-charged with graphite spheres from the moderator element or graphite sphere storage tank via the second diverter valve assembly and the first inlet.

The storage system may further include a spent fuel storage system. The spent fuel storage system may include a plurality of spent fuel storage tanks for permanent storage on site of spent and damaged fuel elements, inlets to the spent fuel storage tanks being operatively coupled to the first diverter valve of the first sort means, a third radiation sensor being located intermediate the first diverter valve and the spent fuel storage tanks to detect any misdirected moderator elements or graphite spheres.

The fuel storage system may further include a temporary fuel storage system. The temporary fuel storage system may include a temporary fuel storage tank for storing in-use fuel elements, the temporary fuel storage tank including an inlet operatively coupled to the first diverter valve of the first sort means and an outlet operatively coupled to the second inlets of the reactor core. Thus, as with the graphite spheres, during the maintenance of the reactor core the fuel spheres may be discharged from the reactor core and, rather than being circulated back to the core, may be temporarily stored in the temporary fuel storage tank whilst maintenance takes place. On completion of maintenance, the fuel spheres may be recharged into the reactor core via the second inlets.

The fuel handling and storage system may include control means operatively coupled to each of the radiation sensors and diverter valves and valve assemblies.

The control means may be a computer which is operable to control operation of the diverter valves to divert moderator elements and fuel elements into their respective circuits on operation of the respective radiation sensor.

The control means may be operable to control feeding of new fuel elements into the reactor core on discharge of spent and damaged fuel elements into the spent fuel storage system, thereby maintaining a preselected number of fuel elements in circulation, including the core and the handling system, the control means being programmed to prevent charging of a new fuel element into the reactor core where a misdirected moderator sphere is detected by the third radiation sensor of the spent fuel storage system, thereby obviating inadvertent alteration of the fuel/moderator ratio in the core.

According to another aspect of the invention there is provided a method of operating a nuclear plant having a nuclear reactor of the pebble bed type, the method including

cycling spherical moderator elements at a predetermined rate through a central generally cylindrical region defined in a core of the reactor; and

cycling spherical fuel elements at a predetermined rate through an annular region defined in the core surrounding the central region.

The method may include temporarily storing the moderator elements outside the core to facilitate maintenance of the reactor.

The method may further include temporarily storing the fuel elements outside the core to facilitate maintenance of the reactor.

According to yet another aspect of the invention there is provided a method of loading a core of a nuclear reactor of the pebble bed type which includes the steps of

filling the core with first moderator elements to form a bed of moderator elements; and

loading simultaneously, second moderator elements into a central region of the core and fuel elements into an annular region of the core at predetermined rates while removing the first moderator elements from the central and annular regions at a predetermined rate so as to form a core having a plurality of spherical moderator elements located in a central region and a plurality of spherical fuel elements located in an annular region around the central region.

The method may include loading the second moderator elements and fuel elements from above while removing the first moderator elements from below.

The invention is now described, by way of example, with reference to the accompanying diagrammatic drawings.

In the drawings,

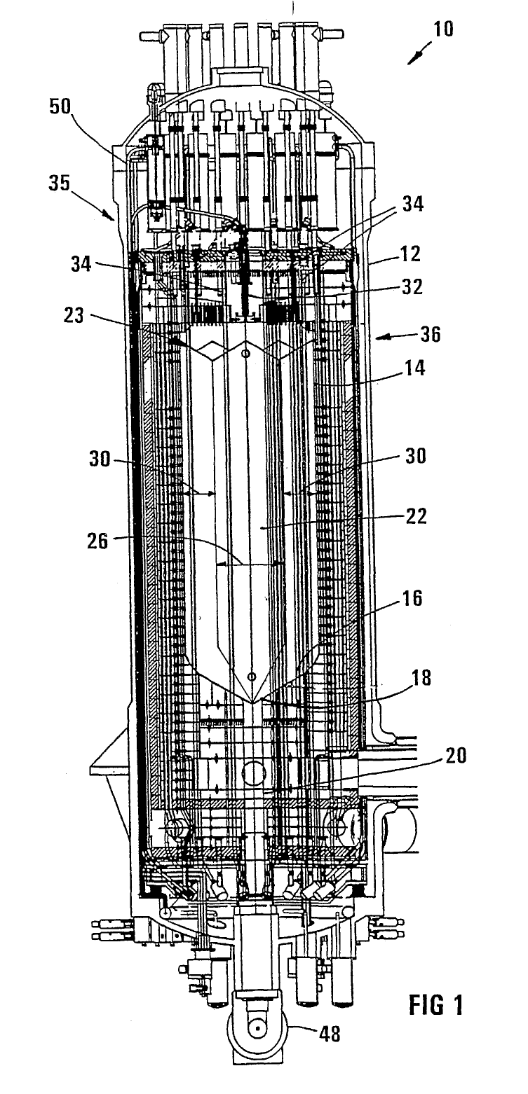

FIG. 1 shows a sectional side view of a nuclear reactor pressure vessel of a nuclear reactor forming part of a nuclear plant in accordance with the invention;

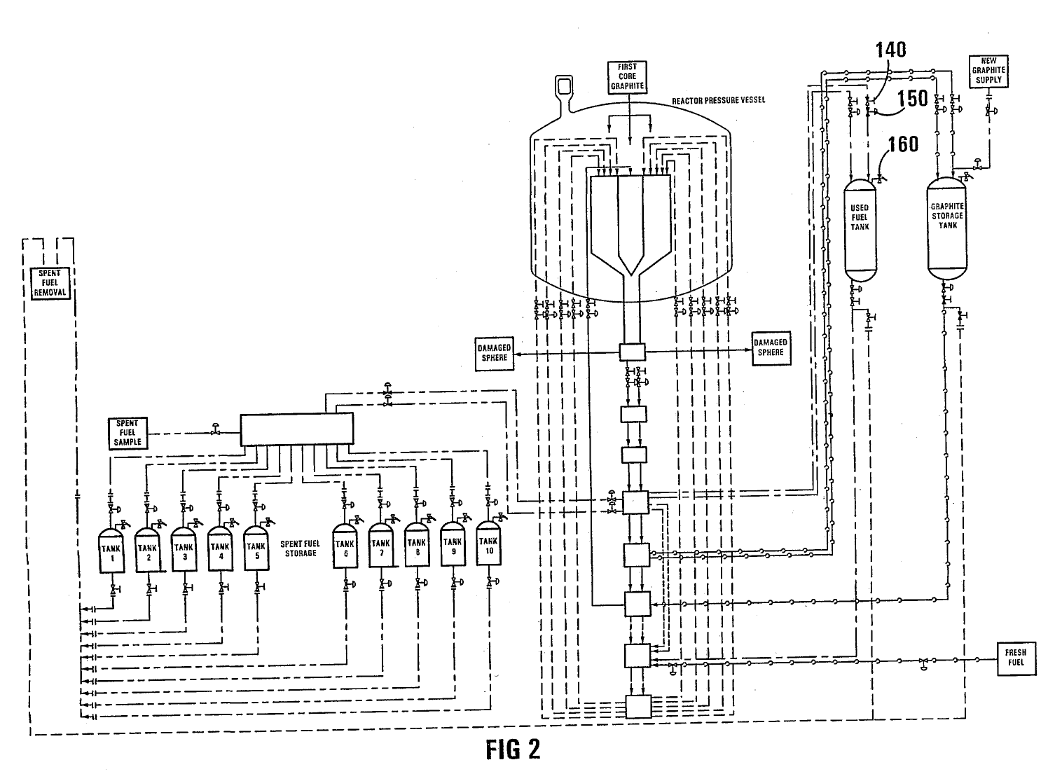

FIG. 2 shows a process flow diagram of a handling system forming part of the nuclear plant;

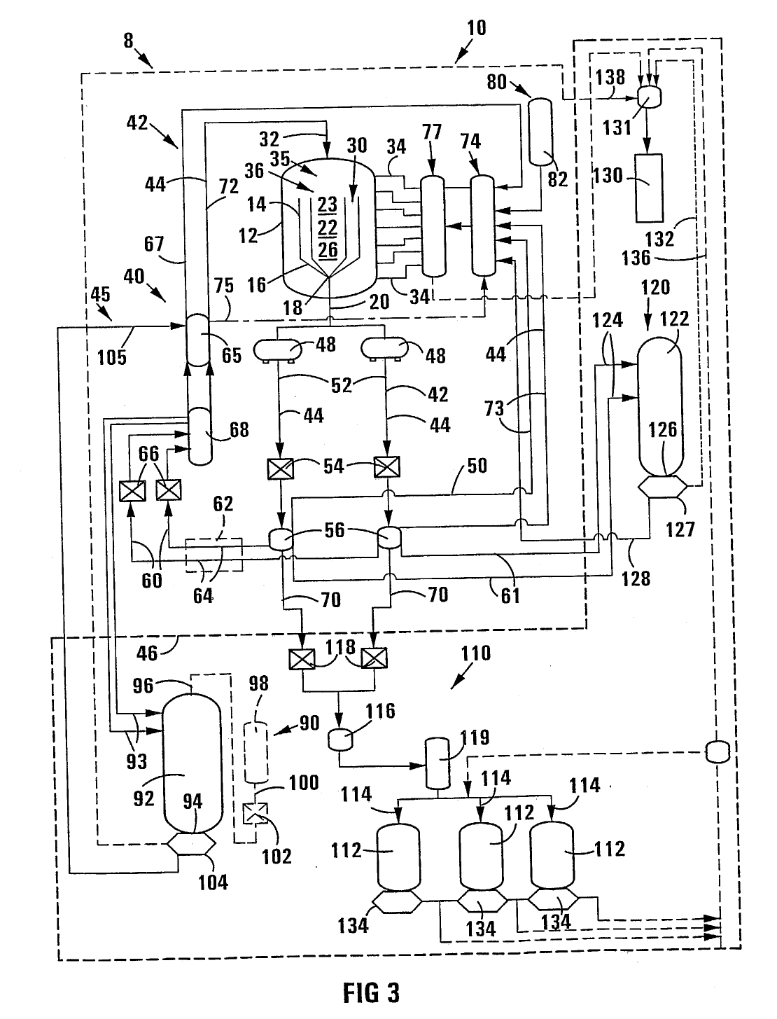

FIG. 3 shows a schematic view of a system layout of the handling system;

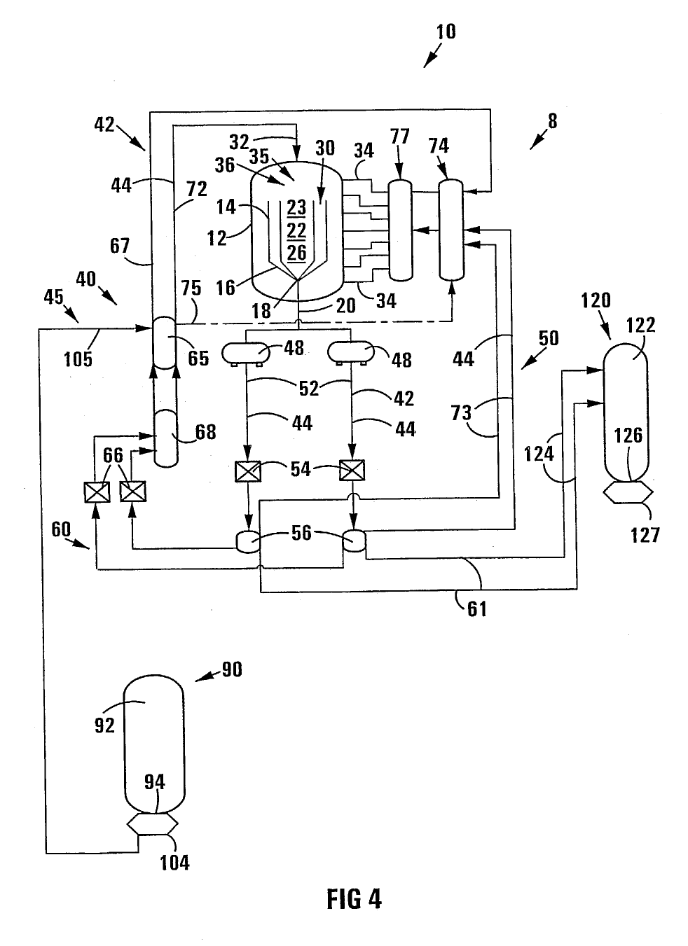

FIG. 4 shows a schematic view of a part of the system operative in de-fuelling mode;

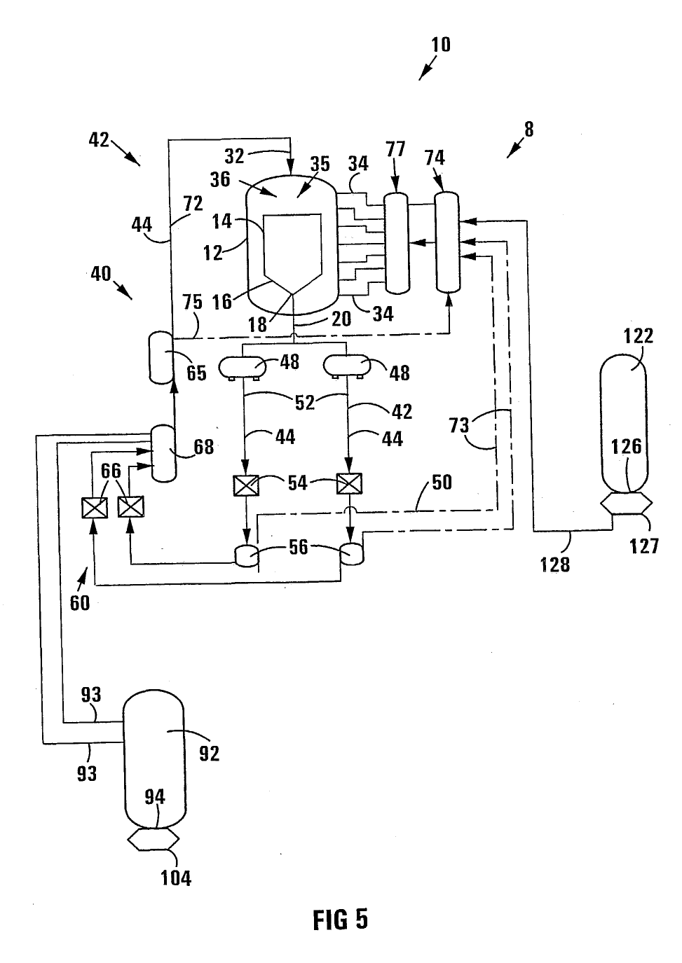

FIG. 5 shows a schematic view of a part of the system operative in re-fuelling mode;

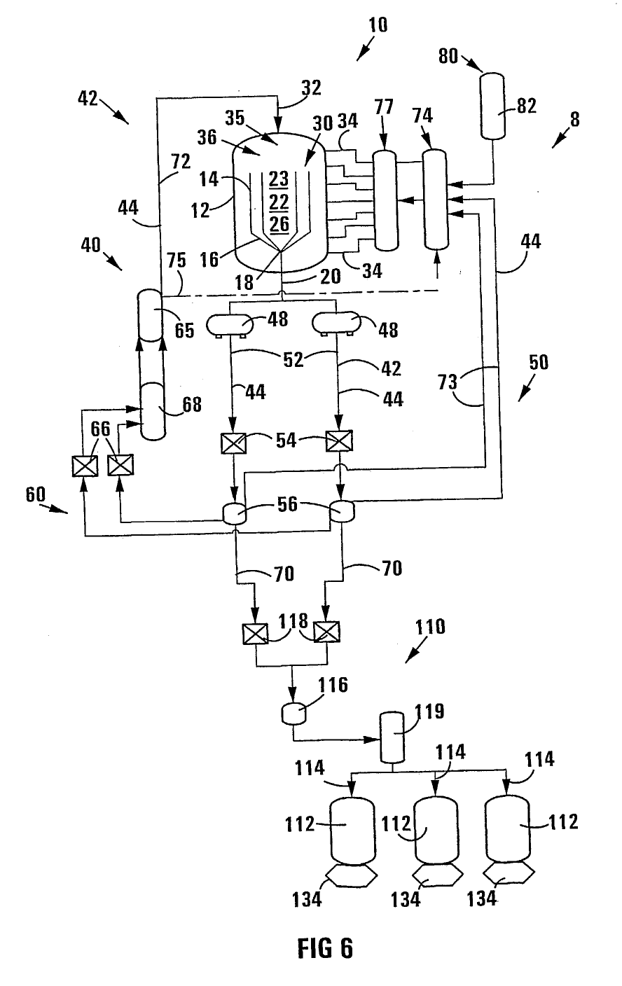

FIG. 6 shows a schematic view of a part of the system operative in normal operating mode;

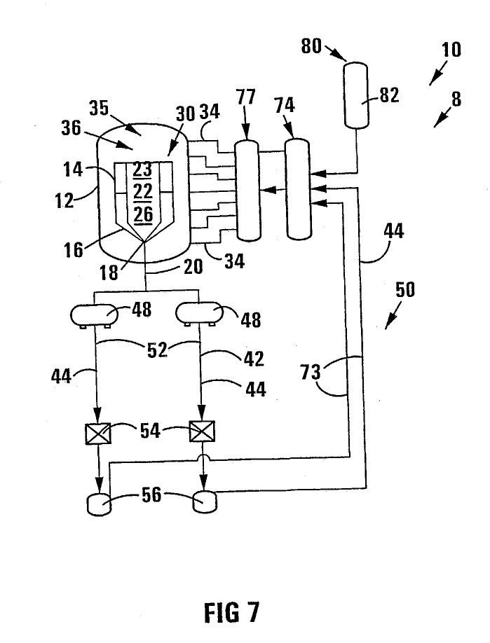

FIG. 7 shows a schematic view of fuel sphere flow during normal operating mode;

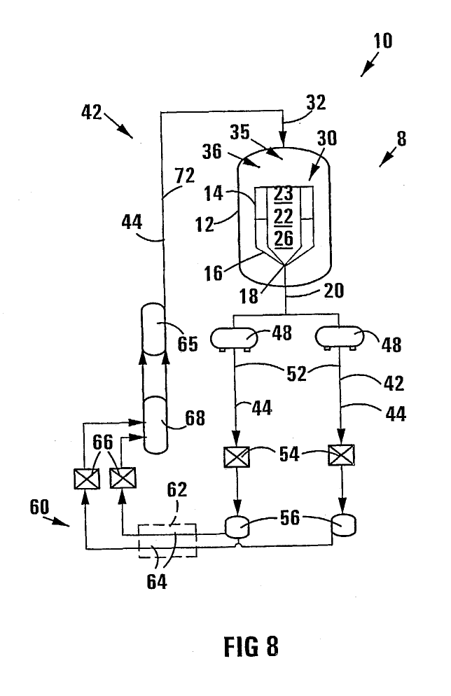

FIG. 8 shows a schematic view of graphite sphere flow during normal operating mode;

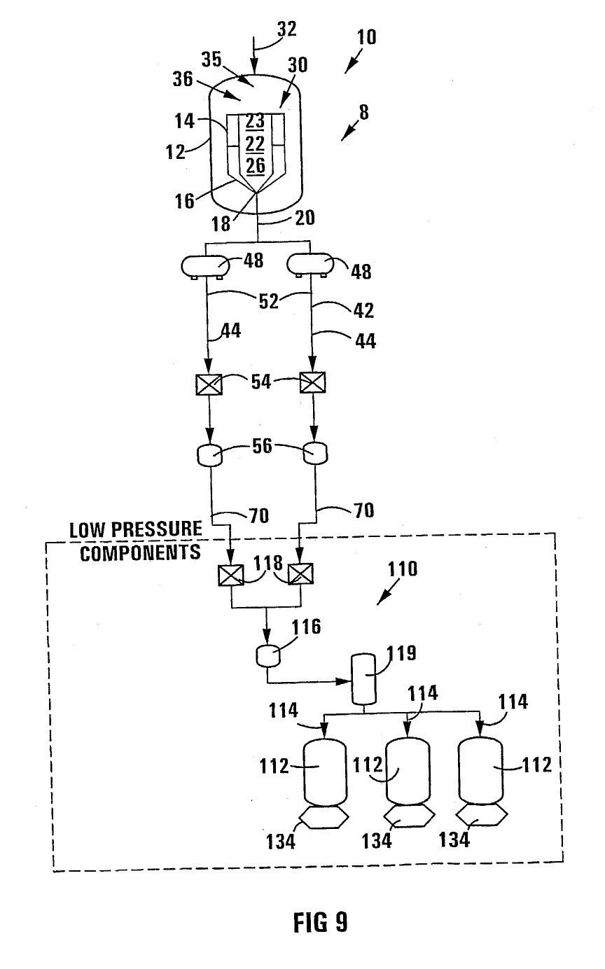

FIG. 9 shows a schematic view of spent fuel flow during normal operating model; and

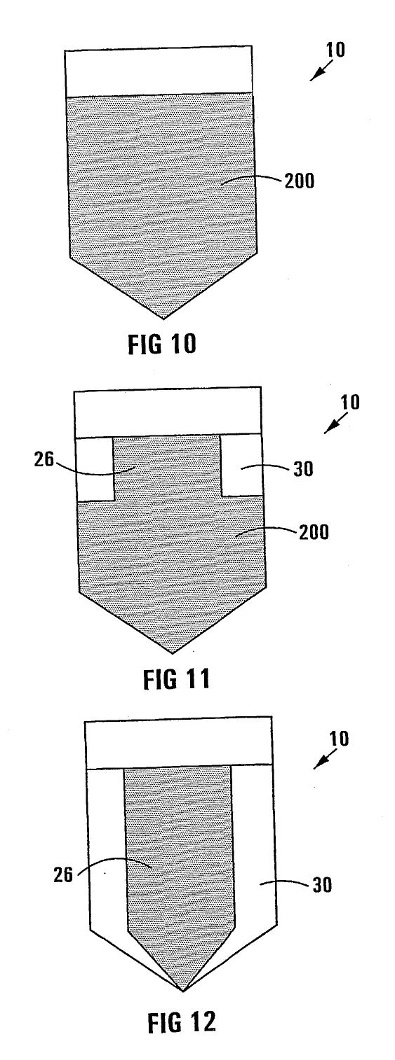

FIGS. 10 to 12 show steps involved in the loading of a core of a nuclear reactor in accordance with the invention.

In the drawings, reference numeral 10 generally indicates a nuclear reactor of the pebble bed type, in accordance with the invention.

The reactor 10 is a high temperature gas cooled reactor, the coolant gas being helium and the reactor has a generally cylindrical pressure vessel 12. Further, the reactor has a core barrel 14 within the pressure vessel 12 and coaxial therewith. The core barrel 14 is generally cylindrical for most of its length and has a funnel-shaped lower end portion 16 which tapers inwardly downwardly towards an operatively lower end 18. A single outlet 20 is defined at the lower end 18 of the core barrel 14, projecting outwardly therefrom and coaxially therewith.

A reactor core 22 is contained within a core region 23 defined by the core barrel 14. The reactor core 22 comprises a plurality of spherical graphite moderator elements (not shown in detail) located in a central generally cylindrical region 26 defined in the core 22 and a plurality of spherical fuel elements (not shown in detail) located in an annular region 30 defined in the core 22 and surrounding the central region 26.

The core barrel 14 has a single first inlet 32 which is configured to load spherical graphite moderator elements or graphite spheres into the central region 26 of the core 22 via the first inlet 32. Further, the core barrel 14 has nine second inlets 34 (three of which are shown in FIG. 1, and only seven of which are indicated schematically in FIG. 3) which are configured to permit spherical fuel elements or fuel spheres to be loaded into the annular region 30 of the core 22 via the said second inlets 34. The first and second inlets (32, 34) are located in an operatively upper end region 35 of the reactor pressure vessel 12. The second inlets 34 are arranged in an angularly spaced relation about and radially spaced from a longitudinal axis of the core barrel 14 and symmetrically spaced with respect to the annular region 30. It will be appreciated that there may be more than one graphite sphere inlet 32 and more, or fewer, than nine fuel sphere inlets 34.

The nuclear reactor 10 forms part of a nuclear plant part of which is generally indicated by reference numeral 8. The plant 8 has a handling system 40 intermediate the outlet 20 and each of the first and second inlets (32, 34), for cycling the graphite spheres and fuel spheres through their respective regions 26 and 30, respectively, of the core 22 at a predetermined rate. The handling system 40 defines a flow path 42 intermediate the outlet 20 and each of the inlets (32, 34). The flow path 42 is defined at least in part by an arrangement of conduit lines 44. Motive force for the moderator and fuel spheres about the handling system 40 is provided, in part, by reactor helium coolant gas from the reactor pressure vessel 12 and the moderator and fuel spheres are entrained in a gas flow stream flowing in the flow path 42.

The handling system 40 has a high pressure region 45 and a low pressure region 46, the low pressure region 46 being indicated by the dashed region labelled 46 in the drawings. The high pressure region 45 comprises those components of the handling system 40 outside the low pressure region 46. In the high pressure region 45 of the handling system 40, the flow path 42 of the handling system 40 is in fluid communication with the reactor core 22 and the gas flow stream is provided by means of reactor coolant gas, being helium, at the pressure of the coolant gas within the reactor pressure vessel 12. The gas flow stream of the low pressure region 46 of the handling system 40 is provided by clean, dry air at relatively low pressure and pressure locks (not shown) are provided in the handling system conduits 44 at boundaries between the high pressure region 45 and the low pressure region 46 to bridge the said boundaries.

The handling system 40 has a fuel sphere flow path 50 which is operative during normal operation of the reactor 10, illustrated schematically in FIG. 7, and a moderator sphere flow path 60 which is also operative during normal operation of the reactor 10, indicated schematically in FIG. 8.

Under normal operating conditions, as shown in FIGS. 6, 7 and 8, fuel spheres and graphite moderator spheres move continually under gravity through the core 22 of the reactor 10 from an operatively upper region 36 of the core barrel 14 to the lower end portion 16 of the core barrel 14. At the lower end 18 of the core barrel 14 they exit the core barrel 14 and hence the reactor pressure vessel 12 via the outlet 20.

A pair of sphere handling machines 48 is connected to the outlet 20 and the machines 48 are operable to feed discharged fuel and moderator spheres one at a time into a pair of discharge flow lines 52. Each of the said sphere handling machines 48 includes a scrap separator (not shown) and scrap cask (not shown) and the machines 48 are operable to detect physically damaged spheres and to remove such spheres from the discharge flow lines 52. On each of the flow lines 52 a first radiation and burn-up sensor 54 is arranged. The sensors 54 are operable to sense and measure nuclear radiation emitted by entrained moderator or fuel spheres in the respective flow lines 52 and to transmit a signal containing information representative of the measurements made. The sensors 54 are also operable to count entrained fuel and moderator spheres. Each of the sensors 54 is operatively coupled to a first diverter valve 56 via a computer controller (not shown). The controller is programmed to control the diverter valves 56 to divert incoming spheres to one of three ports, depending on the status and condition of each respective sphere, information representative of which is transmitted by the radiation and burn-up sensor 54 to the controller. Graphite spheres are diverted into the moderator sphere flow path 60; fuel spheres are diverted into the fuel sphere flow path 50; and spent fuel spheres are diverted into a third spent fuel storage flow line 70, as shown in FIG. 9. Each of the diverter valves 56 also has a fourth port leading to a temporary fuel storage tank 122 via flow lines 61.

Graphite spheres entering the moderator sphere flow path 60 are routed via a temporary storage and inspection region 62. In the temporary storage and inspection region 62, graphite spheres are delayed for a period of time, which may be of the order of five days, in order to facilitate the identification of misdirected fuel spheres which may inadvertently have entered the moderator flow path 60. Also, in the inspection region 62, graphite spheres are inspected for physical defects. Conduits 64 of the flow path 60 in the inspection region 62 are helical in shape (although this is not shown in the drawings) to facilitate X-ray inspection of each passing graphite sphere from all sides. From the inspection region 62, graphite and misdirected fuel spheres are fed past third radiation sensors 66 which are operatively coupled to a third diverter valve (indexer) 68. Both the third diverter valve 68 and the third radiation sensors 66 are connected to the controller and the diverter valve 68 is operable, under control of the controller, to forward fuel and moderator spheres to a transfer valve assembly 65, or to divert graphite spheres to a moderator sphere storage system 90, which will be further described below.

Fuel spheres exiting the outlet 20, which are neither spent nor damaged, are diverted via the first diverter valves 56 into the fuel sphere flow path 50 and, via a pair of second inlet lines 73, to a sphere collector 74 and sphere distributor 77 which is coupled to the controller and operable to distribute fuel spheres in a predetermined sequence to the nine second inlets 34 of the handling system 40.

The transfer valve assembly 65 is operable to permit graphite spheres to travel via an inlet line 72 into the first inlet 32 of the core barrel 14, and to divert misdirected fuel spheres into a flow line 75 leading into the sphere collector 74 and thence, via the second inlets 34, into the annular region 30 of the core 22.

The handling system 40 includes a new fuel storage system 80 for storing new (unused) fuel spheres and for selectively feeding new fuel spheres into the reactor core 22 via the second inlets 34. New fuel spheres are introduced into the handling system 40 from a new fuel storage vessel 82 and pressure lock whence the fuel spheres are introduced to the inlets 34 via the sphere collector 74.

The handling system 40 further includes a moderator sphere storage system 90 for storing graphite moderator spheres. The moderator sphere storage system 90 includes a graphite sphere storage tank 92 having inlets 93 and an outlet 94, the inlets 93 being operatively coupled to the diverter valve 68 of the moderator sphere flow path 60 and the outlet 94 being coupled to the transfer valve assembly 65 of the moderator sphere flow path 60. Thus, by operation of the diverter valve 68, under control of the controller, graphite spheres discharged from the reactor core 22 may be diverted to the graphite sphere storage tank 92 for storing, rather than being recycled back into the reactor core 22, thereby enabling the complete discharge of graphite spheres from the reactor core 22 for maintenance purposes. As required, the reactor core 22 may be recharged with graphite spheres from the graphite sphere storage tank 92 via the transfer valve assembly 65 and thence via the inlet line 72 to the first inlet 32. The graphite sphere storage tank 92 further has a second inlet 96 coupled to a graphite and helium lock 98 via a feed line 100 through which fresh graphite spheres may be introduced into the system 40. A fourth radiation sensor 102 is located in the feed line 100 intermediate the graphite and helium lock 98 and the graphite sphere storage tank 92 for sensing inadvertent attempted introduction of fuel spheres into the graphite sphere storage tank 92. Graphite spheres are loaded from the graphite sphere storage tank 92 into the moderator sphere flow path 60 by means of a third sphere handling machine 104 which is connected to the transfer valve assembly 65 via line 105. The graphite and helium lock 98 and fourth radiation sensor 102 may be portable and are shown in dotted lines in the drawings.

The handling system 40 further includes a spent fuel storage system 110, which is illustrated schematically in FIG. 9. The spent fuel storage system 110 includes ten spent fuel storage tanks 112, of which three are shown on the drawings, for permanent storage on site of spent and damaged fuel spheres. Preferably, the.capacity of the spent fuel storage tanks 112 is calculated to accommodate spent and damaged fuel spheres over the anticipated operational life of the nuclear reactor 10. Inlets 114 to the spent fuel storage tanks 112 are operatively coupled to the first diverter valves 56 via a discharge lock 116. Two fifth radiation sensors 118 are arranged on the spent fuel storage flow lines 70, intermediate the first diverter valves 56 and the discharge lock 116. The sensors 118 are operable to sense graphite spheres which may have been diverted inadvertently into the spent fuel storage system 110. A ten port distribution controller 119 is connected to the spent fuel storage tanks 112 and is operable to divert spent fuel spheres to a predetermined storage tank 112.

The handling system 40 further includes a temporary fuel storage system 120. The temporary fuel storage system 120 has a temporary fuel storage tank 122 for storing in-use fuel spheres on a temporary basis. The temporary fuel storage tank 122 has inlets 124 operatively coupled to the first diverter valves 56 via the flow lines 61, and an outlet 126 operatively coupled to the second inlets 34 of the reactor core barrel 14 via a re-fuelling line 128 leading to the sphere collector 74. As with the graphite spheres, during maintenance of the reactor 10 fuel spheres may be discharged from the reactor core 22 and, rather than being circulated back to the reactor core 22, may be temporarily stored in the temporary fuel storage tank 122 whilst maintenance takes place. On completion of maintenance, the fuel spheres are recharged into the reactor core 22 via the second inlets 34 by means of a fourth sphere handling machine 127. Provision is made for a last core fuel cask 130 and loading station 131, which is connected to the fourth sphere handling machine 127 and the outlet 126 of the temporary fuel storage tank 122 via a fuel line 132. The reactor core 22 may be dumped into the last core fuel cask 130 at the end of the operating life of the reactor 10. The loading station 131 may also be used for the dispatch of spent fuel from the spent fuel storage tanks 112, via a series of fifth fuel handling machines 134 and a spent fuel line 136 and for the unloading of used graphite spheres via a graphite line 138 connect the third sphere handling machine 104 of the graphite sphere storage tank 92 to the loading station 131.

It will be appreciated that in a plant 8 having a reactor 10 of the pebble bed type operating according to a multi-pass fuelling scheme, fuel spheres are moved through the core 22 more than once, for example up to ten times, before being exhausted (burnt-up) to the extent that they are no longer utile. The nuclear plant 8 in accordance with the invention as described herein includes a handling system 40 which is operable to keep fuel and graphite spheres separate after exiting from the reactor core 22. The fuel and graphite spheres are fed into the reactor core 22 above the pebble bed by inlet supply tubes (32, 34) arranged in a specific order to ensure the two zone core loading with graphite spheres in the central region 26 and fuel spheres in the annular region 30 surrounding the graphite-filled central region 26. The main components of the handling system 40 are preferably located in shielded, individual compartments below the reactor pressure vessel 12. The spent fuel storage system 110, which is designed as a lifetime spent fuel store and post operations intermediate store is located in a lower part of the reactor building. The handling system 40 provided according to the invention enables the loading of the core barrel 14 with graphite spheres and the loading of new fuel spheres into the core 22. Further, the handling system 40 provides for the removing of misdirected fuel spheres from the moderator flow path 60 and the prevention of erroneously discharged graphite spheres initiating the loading of new fuel spheres, by means of radiation sensors 118 arranged on the spent fuel storage flow lines 70 leading to the spent fuel storage tanks 112. Thus, while the controller is operable to trigger the loading of a new fuel sphere to replace each burnt-up fuel sphere that is diverted to the spent fuel storage tanks 112, a graphite sphere detected by the sensors 118 will not initiate the loading of the new fuel sphere. Still further, the fuel handling and storage system 40 provides for the removal of fuel and graphite spheres from the discharge outlet 20, the separation of damaged fuel and graphite spheres, the separation of fuel, absorber and graphite spheres, the re-circulating of graphite spheres and the recirculation of partially used fuel spheres through the core 22. Burn-up of partially used fuel spheres is measured and spent fuel spheres are discharged into the spent fuel storage system 110. It will be appreciated that in a PBR reactor it is anticipated that absorber spheres may be included in the core 22. While the treatment of absorber spheres from the core 22 is not specifically described herein, it is anticipated that the handling system 40 may be readily adapted to separate, store and circulate such absorber spheres in a manner analogous to that described herein for moderator and fuel spheres.

Under normal operation, fuel and graphite spheres are conveyed from the core 22 through the fuel and graphite sphere discharge outlet 20 to the two sphere handling machines 48 that can deliver a continuous pebble flow from the discharge outlet 20 downstream of each machine 48. Damaged spheres are discarded to the spent fuel storage system 110. The graphite and fuel spheres pass through the discharge flow lines 52 and each fuel sphere or graphite sphere is released individually for radiation measurement, after which they are separated by a diverter valve 56. The burn-up and radiation sensors 54 have the capability of measuring the burn-up of fuel spheres and of distinguishing between fuel spheres and graphite spheres. Fuel spheres are transported to the outside annular region 30 of the core 22, while graphite spheres are transported to the graphite inspection region 62. Further radiation sensors (not shown) are arranged in the inspection region 62. Should a fuel sphere be detected by a buffer region radiation sensors, the normal operation of the handling system 40 is suspended. The contents of the inspection region 62 are re-circulated until the fuel spheres are removed and diverted to the sphere collector 74 by means of the transfer valve assembly 65 and flow line 75. When a used fuel sphere is detected by the burn-up sensor 54, the diverter valve 56 will send the spent fuel sphere to the spent fuel storage tanks 112.

In the system as described, fuel and graphite spheres are conveyed in conduit lines 44, which preferably are horizontally or vertically orientated, partly by gravity but predominantly pneumatically by using mainly the primary coolant gas at primary systems pressure. Monitoring of fuel sphere movement is performed with the aid of measurement and counting instruments (54, 66, 118), whose signals provide input to the control system which actuates the operating components in valve indexers (56, 68, 65) of the system 40.

Fuel spheres are forwarded to the reactor 10 pneumatically by primary coolant. Two types of forwarding systems are used. The first forwarding system uses the extracted gas from the main gas stream. The second forwarding system is a blower system. The first forwarding system by-passes the blower (not shown) so that the blower can be maintained. In exceptional cases, such as an initial loading of the core 22 or re-filling of the core 22 with graphite spheres after emptying for inspection or repair, pneumatic forwarding is performed in air under pressure with the reactor pressure vessel 12 vented.

Under normal operation, the graphite and fuel spheres are separated on a continuous basis. The radiation and burn-up sensors 54 perform the functions of distinguishing fuel from graphite from absorber spheres and giving a count of such spheres passing the sensor 54 and measuring radiation and burn-up of fuel spheres. Each diverter valve 56 is operable to send a fuel or moderator sphere in one of three directions: either down the spent fuel storage flow line 70; or into the fuel sphere flow path line 50; or into the moderator sphere flow path 60.

The graphite spheres are sent to a graphite inspection region 62 (buffer line) during normal operations, the buffer line 62 holding a stock of graphite spheres. The spheres in the buffer line 62 are monitored for radiation. This allows time for any misdirected fuel spheres to be detected and returned to sphere collector 74.

Importantly, the handling system 40 provides for the de-fuelling and re-fuelling of the core 22 by transfer of the core inventory from the reactor 10 into separate graphite and fuel storage tanks (92, 122) located in an area adjacent to the reactor pressure vessel 12 during maintenance intervention requiring the venting of the main power system to atmosphere. After maintenance, the handling system 40 provides for the re-loading of the core 22 from these tanks (92, 122) during re-fuelling of the core 22. The configuration of the handling system 40 during de-fuelling mode is shown schematically in FIG. 4, while the configuration of the handling system 40 during re-fuelling is shown schematically in FIG. 5. Thus, it is an important advantage of the present invention that maintenance can be carried out on the reactor core components and pressure vessel 12 during the lifetime of the nuclear reactor 10 at relatively low cost and relatively quickly.

The fuel handling and storage system 40 provides that the correct ratio and distribution of graphite and fuel spheres is maintained. Further, the main power system primary loop is isolated from the fuel handling and storage system 40. The simultaneous loading of graphite and fuel spheres during re-fuelling mode, avoids horizontal movement of fuel spheres to the centre 26 of the core 22 and ensures adequate core volume is maintained.

De-fuelling of the core 22 will only take place if it is necessary to open the main power system to the atmosphere for maintenance. To prevent fuel corrosion, it is necessary to store fuel spheres under helium pressure in the fuel storage tank 122 adjacent to the reactor pressure vessel 12. The reactor pressure is reduced and the low pressure region is connected to the high pressure region by the opening of pressure valves. Fuel and graphite spheres are separated by using radiation sensors 54. The graphite spheres contained in the core 22 together with the graphite spheres which have been retrieved from the graphite storage tank 92 will be re-circulated to the core 22 and loaded into both the central region 26 and the annular region 30 thereof. The loading of the entire core region 23 with graphite spheres is to avoid horizontal movement of the fuel spheres to the central region 26 of the core 22 and to maintain adequate core volume. The fuel spheres are delivered via the inlets 124 to the water cooled and critically safe fuel storage tank 122. During the de-fuelling mode, the spent fuel storage system 110 is out of service. Further, no new fuel loading takes place and no new graphite sphere loading or replenishment takes place.

After maintenance to the reactor power system, re-fuelling will commence. The required operational pressure and temperature of the helium will be maintained and the core 22 filled with graphite spheres to form a bed 200 of moderator elements or graphite spheres. The bed 200 of moderator elements is formed by loading the moderator elements or graphite spheres into the core barrel 14 from above. Once the bed 200 has been formed to the desired level, moderator elements are fed through the first inlet 32 and fuel elements are fed through the second inlets 34 into the regions 26, 30. Simultaneously, the moderator elements forming the bed 200 are extracted from below through the outlet 20 at the same rate as moderator elements and fuel elements are fed into the core barrel. In this away, as illustrated in FIG. 11 of the drawings, a core can be built up having a central region 26 of moderator elements and an annular region 30 of fuel elements. This procedure is continued until all of the moderator elements of the bed 200 have been removed and the core is fully formed as indicated in FIG. 12 of the drawings. Once the two zone core 26, 30 is established (FIG. 12), the fuel storage tank 122 will be empty and the graphite storage tank 92 will be approximately three quarters full and a graphite buffer storage tank (not shown) will be full. At this point, start up of the reactor 10 can commence. The re-fuelling equipment is taken out of service and isolated from the high pressure components by closing the isolation valves between the low 46 and high pressure circuits 46.

The process of operation of the reactor handling system 40, including the moderator and fuel sphere storage systems 90, 110, 120 is illustrated in the process flow diagram of FIG. 2, in which legends and descriptions of major components are included for ease of use. In FIG. 2, process blocks a, b and c are together embodied in the first radiation and burn up sensors 54 of the example of the invention illustrated in FIG. 1. Further, in FIG. 2: the symbol indicated by reference numeral 140 represents a manually operated valve; the symbol indicated by reference numeral 150 represents an automatically controlled valve; and the symbol indicated by reference numeral 160 indicates a pressure relief valve.

1. A nuclear plant which includes:
a nuclear reactor having
a core containing means having at least one outlet through which moderator elements and fuel elements can be discharged from the core;
a first inlet positioned to permit moderator elements to be loaded into a central region of the core;
a plurality of second inlets configured to permit fuel elements to be loaded into an annular region of the core surrounding the central region, the second inlets being located in an angular spaced relation about a longitudinal axis of the core proximate the annular region; and
a handling system immediate the or each outlet and the or each second inlet for cycling the moderator elements and the fuel elements through their respective regions of the core at a predetermined rate.

2. A nuclear plant as claimed in claim 1, in which the nuclear reactor is a pebble bed reactor and the core containing means is a core barrel, the core barrel being generally cylindrical in shape, an operatively lower end portion of the barrel tapering inwardly to provide a funnel-shaped operatively lower end, a single outlet being defined at the operatively lower end of the barrel, a single first inlet being located at an operatively upper end of the barrel, proximate the central region of the core and a plurality of second inlets being located in an angularly spaced relation about a longitudinal axis of the barrel proximate the annular region of the core and symmetrically spaced with respect to the annular region.

3. A nuclear plant as claimed in claim 2, in which the handling system defines a flow path intermediate the outlet and each of the inlets.

4. A nuclear plant as claimed in claim 3, in which the flow path includes by a conduit arrangement including conduit lines.

5. A nuclear plant as claimed in claim 3 or claim 4, in which motive force for the moderator and fuel elements about the handling system is provided, at least partly, by a gas under pressure, the moderator and fuel elements being entrained, in use, in a gas flow stream flowing through the flow path.

6. A nuclear plant as claimed in claim 5, in which motive force for the moderator and fuel elements is provided, at least in part, by gravitational force.

7. A nuclear plant as claimed in claim 5 or claim 6, in which the flow path of the handling system is in fluid communication with the reactor core and the gas flow stream is provided by means of reactor coolant gas.

8. A nuclear plant as claimed in any one of claims 3 to 7, inclusive, in which the handling system has a fuel element flow path and a moderator element flow path, the handling system further including a first sort means for separating moderator elements from fuel elements in the flow path and for entraining moderator elements in a gas flow stream of the moderator element flow path and fuel elements in a gas flow stream of the fuel element flow path.

9. A nuclear plant as claimed in claim 8, in which the first sort means includes a first sensor means operatively coupled to a first diverter valve.

10. A nuclear plant as claimed in claim 9, in which the first sensor means is a radiation sensor and Is operable to detect and measure nuclear radiation emitted by moderator elements and fuel elements in the flow stream and to generate a signal containing data representative of the radiation detected and measured, the first diverter valve being operable to divert the flow stream into a first flow path, being the moderator element flow path, a second flow path, being the fuel element flow path, and a third flow path, being a discharge flow path for discharging burnt up or damaged fuel elements.

11. A nuclear plant as claimed in any one of claims 8 to 10, inclusive, in which the moderator element flow path includes a second sort means.

12. A nuclear plant as claimed in claim 11, in which the second sort means includes a second sensor means operatively coupled to a second diverter valve assembly, the second sensor means being a radiation sensor which is operable to detect and measure nuclear radiation emitted by moderator elements and fuel elements in the flow stream of the moderator flow path and to generate a signal containing data representative of the radiation detected and measured, the second diverter valve assembly being selectively operable to divert moderator elements into a moderator inlet line for re-loading into the reactor core and, on detection of a fuel element in the moderator element flow path, to divert such a fuel element back into the annular region of the reactor core.

13. A nuclear plant as claimed in claim 11 or claim 12, in which the moderator element flow path includes a buffer storage means for storing elements in the moderator element flow path to provide a time delay to assist in separating misdirected fuel elements from moderator elements in the moderator element flow path.

14. A nuclear plant as claimed in claim 12 or claim 13, in which the handling system includes a storage system.

15. A nuclear plant as claimed in claim 14, in which the storage system includes a new fuel storage system for storing new fuel elements and for feeding new fuel elements at predetermined intervals into the reactor core via the second inlets, a moderator element storage system for storing graphite moderator elements, the moderator element storage system including a moderator element storage tank having an inlet and an outlet, the inlet being operatively coupled to the second diverter valve assembly of the moderator element flow path and the outlet being coupled to the same second diverter valve assembly of the moderator element flow path.

16. A nuclear plant as claimed in claim 14 or claim 15, in which the storage system further includes a spent fuel storage system.

17. A nuclear plant as claimed in claim 16, in which the spent fuel storage system includes a plurality of spent fuel storage tanks for permanent storage on site of spent and damaged fuel elements, inlets to the spent fuel storage tanks being operatively coupled to the first diverter valve of the first sort means, a third radiation sensor being located intermediate the first diverter valve and the spent fuel storage tanks to detect any misdirected moderator elements.

18. A nuclear plant as claimed in claim 17, in which the fuel storage system further includes a temporary fuel storage system.

19. A nuclear plant as claimed in claim 18, in which the temporary fuel storage system includes a temporary fuel storage tank for storing in-use fuel elements, the temporary fuel storage tank including an inlet operatively coupled to the first diverter valve of the first sort means and an outlet operatively coupled to the second inlets of the reactor core.

20. A nuclear plant as claimed in any one of claims 14 to 19, inclusive, in which the fuel handling and storage system includes control means operatively coupled to each of the radiation sensors and diverter valves and valve assemblies.

21. A nuclear plant as claimed in claim 20, in which the control means is a computer which is operable to control operation of the diverter valves to divert moderator elements and fuel elements into their respective circuits on operation of the respective radiation sensor.

22. A nuclear plant as claimed In claim 21, in which the control means is operable to control feeding of new fuel elements Into the reactor core on discharge of spent and damaged fuel elements into the spent fuel storage system, thereby maintaining a preselected number of fuel elements in circulation, including the core and the handling system, the control means being programmed to prevent charging of a new fuel element into the reactor core where a misdirected moderator sphere is detected by the third radiation sensor of the spent fuel storage system, thereby obviating Inadvertent alteration of the fuel/moderator ratio in the core.

23. A method of operating a nuclear plant having a nuclear reactor of the pebble type, the method including:
cycling spherical moderator elements at a predetermined rate through a central generally cylindrical region defined in a core of the reactor; and
cycling spherical fuel elements at a predetermined rate through an annular region defined In the core surrounding the central region, the moderator and fuel elements being extracted from the reactor through a centrally disposed discharge opening leading from the bottom of the reactor, the moderator elements being fed into the reactor through a first inlet leading into the top of the reactor and positioned to discharge the moderator elements onto a central region of the core and the fuel elements being fed into the reactor through a plurality of second inlets leading into the top of the reactor at positions arranged around and outwardly of the first inlet so as to discharge the fuel elements onto an annular region of the core surrounding the central region.

24. A method as claimed in claim 23, which includes temporarily storing the moderator elements outside the core to facilitate maintenance of the reactor.

25. A method as claimed in claim 23 or claim 24, which further includes temporarily storing the fuel elements outside the core to facilitate maintenance of the reactor.

26 A method of loading a core of a nuclear reactor of the pebble bed type which includes the steps of
filling the core with first moderator elements to form a bed of moderator elements; and
loading simultaneously, second moderator elements into a central region of the core through a first inlet leading into the top of the reactor and fuel elements through a plurality of second inlets leading into the top of the reactor at positions arranged around and outwardly of the first inlet into an annular region of the core at predetermined rates while removing the first moderator elements from the central and annular regions at a predetermined rate so as to form a core having a plurality of spherical moderator elements located in a central region and a plurality of spherical fuel elements located in an annular region around the central region.

27. A method as claimed in claim 26, which includes loading the second moderator elements and fuel elements from above while removing the first moderator elements from below.

28. A nuclear plant as claimed in claim 1, substantially as described an illustrated herein.

29. A method of operating a nuclear plant as claimed in claim 23, substantially as described an illustrated herein.

30. A method of loading a core of a nuclear reactor as claimed in claim 26, substantially as described and illustrated herein.

31. A new plant or method, substantially as described herein.
